(19) United States
(12) Patent Application Publication
(10) Pub. No.: US 2011/0271032 A1
(43) Pub. Date: Nov. 3, 2011

(54) ACCESS DEVICE AND MEMORY CONTROLLER

(75) Inventors: Hideyuki Yamada, Osaka (JP); Masahiro Nakanishi, Kyoto (JP)

(73) Assignee: PANASONIC CORPORATION, Osaka (JP)

(21) Appl. No.: 13/143,936

(22) PCT Filed: Jul. 27, 2010
(86) PCT No.: PCT/JP2010/004759

§ 371 Date: Jul. 11, 2011

(30) Foreign Application Priority Data
Jul. 30, 2009 (JP) 2009-177878

(51) Int. Cl. G06F 12/02

(52) U.S. Cl. 711/102; 711/E12.007

(57) ABSTRACT

Refresh to be performed together with normal processing may fail to be performed for a sufficiently long period of time due to the specification requirements. In this case, data loss can occur in an area that has not been refreshed for a sufficiently long period of time. An access module (130) receives the status of data stored in a nonvolatile memory (120) from a nonvolatile memory module (100), and determines whether the data needs maintenance based on the data status, and also determines whether the maintenance is enabled based on the system status of the access module (130). In this case, data maintenance is performed without being required to be performed together with normal system processing. This enables the maintenance to be performed with a sufficiently long processing time allocated to the maintenance, and improves the data retention properties.

### TECHNICAL FIELD

The present invention relates to an access device that rewrites data to a nonvolatile memory device, a memory controller that controls a nonvolatile memory, a nonvolatile memory device including the nonvolatile memory and the memory controller, and a nonvolatile memory system including the access device and the nonvolatile memory device.

### BACKGROUND ART

Nonvolatile memory devices (nonvolatile memory modules) that include a rewritable nonvolatile memory have attracted widespread popularity and are used mainly in semiconductor memory cards. Although the nonvolatile memory modules are more expensive than optical discs and tape media, they are compact, lightweight, and earthquake-resistant, and can be handled easily. These advantages have increased the popularity of the nonvolatile memory modules as recording media for portable devices, such as digital still cameras and mobile telephones. While expanding the range of applications, the nonvolatile memory modules are now used not only in the above consumer devices but also in professional moving image recorders used at broadcasting stations.

Such a nonvolatile memory module includes a flash memory as a nonvolatile main memory and a memory controller for controlling the flash memory. The memory controller controls reading from and writing to the flash memory in accordance with a read command and a write command transmitted from an access device (access module), such as a digital still camera or a mobile telephone.

The flash memory requires a relatively long time to write or erase data in its memory cell array, which is a recording unit defined for the flash memory. To shorten the time required for data writing or data erasure, the flash memory is formed in a manner that data stored in a plurality of memory cells can be erased at a time or data can be written into a plurality of memory cells at a time. More specifically, the flash memory consists of a plurality of physical blocks (units for erasure), each of which includes a plurality of pages (units for writing). Data is erased from the flash memory in units of physical blocks, whereas data is written to the flash memory in units of pages.

To satisfy the recent demand for larger capacity and lower cost, flash memories that can store 2-bit or more information in a single memory cell, which can be multivalued NAND flash memories, have recently become major flash memories. However, the data retention properties of such multivalued NAND flash memories are poorer than the data retention properties of conventional binary NAND flash memories. As the flash memories tend toward even larger capacities, the flash memories will be more strongly required to achieve the data integrity of their memory cells.

To enhance the data integrity of nonvolatile memories, nonvolatile memory modules may conventionally use error correcting codes (ECCs) to detect and correct erroneous data. However, while data read from a nonvolatile memory can be corrected using an ECC, data that has not been read and has been stored in a memory cell for a long period of time can accumulate errors. Such data can accumulate so many errors that cannot be corrected using an ECC. Also, only a specific memory cell in a memory cell array can be read frequently. In this case, the threshold voltage for other memory cells of the same array can change, and the read disturb can occur in the memory cell array.

To overcome these problems, the nonvolatile memory needs processing to retain data, or maintenance, which can be, for example, data refreshing (data rewriting) performed regularly. With a technique described in Patent Literature 1, the number of errors occurring in data is determined when the data is read from a nonvolatile memory. When the number of errors exceeds a criterion value, the data stored in the nonvolatile memory is to be refreshed. The refresh is then performed together with the processing performed when the nonvolatile memory module is powered on or when the memory nonvolatile module is initialized. In this manner, the conventional technique maintains the integrity of data recorded on the nonvolatile memory to or above a sufficiently high level, while also preventing the data reading speed and the data writing speed from being lowered by such refresh processing.

### CITATION LIST

### Patent Literature

Patent Literature 1: Japanese Unexamined Patent Publication No. 2008-90778

### SUMMARY

### Technical Problem

With the technique described in Patent Literature 1, the refresh is performed together with the normal processing performed when, for example, the module is powered on or initialized. When a large amount of data needs to be refreshed in the memory area of the nonvolatile memory, the processing time for the refresh may be long. The long refreshing time can disable the specification requirements to be satisfied. If the refresh time is shortened to satisfy the specification requirements, the refresh may be insufficient. Data loss can occur in an area that has not been refreshed for a sufficiently long period of time. Also, the poorer data retention properties of multivalued flash memories may further increase the risk of such data loss.

Moreover, the data maintenance, such as the refresh, requires a certain amount of power consumption. Portable devices in particular are preferably required to consider the level of their batteries when maintenance is performed. However, the conventional technique fails to consider the device conditions including the battery level when maintenance is performed.

To solve the above problem, it is an object of the present invention to provide an access device, a nonvolatile memory device, a memory controller used in a nonvolatile memory device, and a nonvolatile memory system that improve their data retention properties and expand the range of their applications to various devices including portable devices.

### Solution to Problem

A first aspect of the present invention provides an access device that accesses a nonvolatile memory device including a nonvolatile memory. The access device includes an adaptive command unit.

The adaptive command unit determines whether data stored in the nonvolatile memory needs maintenance based on a data retention status of the nonvolatile memory obtained from the nonvolatile memory device, and determines whether maintenance is to be performed based on whether the access device is in a system status in which maintenance is enabled and based on whether the data stored in the nonvolatile memory needs maintenance, and generates a maintenance command to the nonvolatile memory device when determining that the maintenance is to be performed.

In this access device, the adaptive command unit determines whether maintenance is enabled based on the system status of the access device, and generates a maintenance command to the nonvolatile memory device when determining that the maintenance is to be performed. This enables data maintenance to be performed in accordance with the system status of a nonvolatile memory system including, for example, the access device and the nonvolatile memory system, without requiring the maintenance to be performed together with normal processing of the system.

This enables the maintenance to be performed with a sufficiently long processing time allocated to the maintenance, and improves the data retention properties of the nonvolatile memory device.

A second aspect of the present invention provides the access device of the first aspect of the present invention in which the adaptive command unit includes a system status monitoring unit, a maintenance determination unit, and a command generation unit.

The system status monitoring unit monitors the system status of the access device. The maintenance determination unit determines whether the maintenance is to be performed based on a monitoring result obtained by the system status monitoring unit and based on whether the data stored in the nonvolatile memory needs maintenance. The command generation unit generates a maintenance command to the nonvolatile memory device in accordance with a determination result obtained by the maintenance determination unit.

A third aspect of the present invention provides the access device of the second aspect of the present invention in which the system status monitoring unit monitors a processing status of the access device, and provides information indicating that maintenance is enabled when determining that the access device is not engaged in normal processing. The maintenance determination unit determines that the maintenance is to be performed when determining that the data stored in the nonvolatile memory needs maintenance and further receiving from the system status monitoring unit the information indicating that maintenance is enabled. The command generation unit generates a maintenance command to the nonvolatile memory device when the maintenance determination unit determines that the maintenance is to be performed.

In this access device, the adaptive command unit determines whether maintenance is enabled based on the system status of the access device, and generates a maintenance command to the nonvolatile memory device when determining that the maintenance needs to be performed. This enables data maintenance to be performed in accordance with the system status of a nonvolatile memory system including, for example, the access device and the nonvolatile memory system, without requiring the maintenance to be performed together with normal processing of the system.

This enables the maintenance to be performed with a sufficiently long processing time allocated to the maintenance, and improves the data retention properties of the nonvolatile memory device.

The normal processing refers to the processing that involves at least a predetermined amount of communication performed between the access device and the nonvolatile memory device, and specifically includes initialization of the nonvolatile memory device, data reading, and data writing. The access device performs maintenance of the nonvolatile memory device while the access device is not engaged in normal processing. This enables the maintenance to be performed without lowering the processing performance of the nonvolatile memory system including the access device and the nonvolatile memory device.

A fourth aspect of the present invention provides the access device of the first aspect of the present invention in which the maintenance determination unit stores at least one address of the nonvolatile memory that needs maintenance, and selects an address for which the maintenance is to be performed from the at least one address when receiving from the system status monitoring unit information indicating that maintenance is enabled. The command generation unit generates a maintenance command for performing maintenance for the address of the nonvolatile memory device selected by the maintenance determination unit.

A fifth aspect of the present invention provides the access device of the first aspect of the present invention further including a system control unit that executes system control of the access device. The maintenance determination unit stores at least one address of the nonvolatile memory that needs maintenance, and provides information about the at least one address of the nonvolatile memory to the system control unit.

A sixth aspect of the present invention provides the access device of the fifth aspect of the present invention further including a power supply unit that supplies power to the access device. The system control unit determines a minimum battery level to be reserved by the power supply unit based on the information about the at least one address of the nonvolatile memory, and controls the power supply unit and the access device in a manner to reserve the determined minimum battery level.

This access device determines whether maintenance is enabled while monitoring the system management status including the battery level. This reduces the risk of, for example, the battery level reaching zero and forcing the system to shut down during the maintenance processing.

A seventh aspect of the present invention provides the access device of the fourth aspect of the present invention further including a data management information storage unit storing data management information for managing data stored in the nonvolatile memory. The maintenance determination unit changes an order in which maintenance is to be performed for the at least one address in accordance with a status of data stored in the nonvolatile memory by referring to the information stored in the data management information storage unit.

This access device changes the processing order of the maintenance in accordance with the data status of the nonvolatile memory. This enables maintenance to be performed for memory areas of the nonvolatile memory sequentially in the order of the need for such maintenance. As a result, the access device improves the data retention properties.

An eighth aspect of the present invention provides the access device of the fourth aspect of the present invention further including a data management information storage unit storing data management information for managing data stored in the nonvolatile memory. The maintenance determination unit voluntarily determines and stores an address for which maintenance needs to be performed in accordance with a status of data stored in the nonvolatile memory by referring to the information stored in the data management information storage unit without receiving information about the status of data stored in the nonvolatile memory from the nonvolatile memory device.

This access device voluntarily determines and stores an address for which maintenance needs to be performed in accordance with the data status of the nonvolatile memory that the access device manages without receiving information about the data status of the nonvolatile memory from the nonvolatile memory device. In this case, the access device can control the maintenance to be performed. For example, the access device can solely determine an address for which maintenance is to be performed among predetermined addresses of the nonvolatile memory by managing the write history of the predetermined addresses of the nonvolatile memory. This improves the data retention properties of the nonvolatile memory.

A ninth aspect of the present invention provides the access device of one of the first to eighth aspects of the present invention in which the maintenance includes refresh and/or wear leveling of the nonvolatile memory.

A tenth aspect of the present invention provides a memory controller used in a nonvolatile memory device that reads and/or writes data in accordance with a command provided from an access device for reading data from and writing data to a nonvolatile memory included in the nonvolatile memory device. The memory controller includes an error correction unit and a maintenance request unit.

The error correction unit determines the number of errors included in data read from the nonvolatile memory, and corrects an error included in the read data. The maintenance request unit generates a maintenance request indicating that the nonvolatile memory needs maintenance to the access device when the number of errors determined by the error correction unit is greater than or equal to a criterion value.

The maintenance request unit dynamically changes the criterion value used to determine whether to generate a maintenance request in accordance with a status of data stored in the nonvolatile memory. The maintenance includes refresh and/or wear leveling of the nonvolatile memory.

An eleventh aspect of the present invention provides a nonvolatile memory device for reading and/or writing data in accordance with a command provided from an access device. The nonvolatile memory device includes a nonvolatile memory storing data, and the memory controller of the tenth aspect of the present invention.

A twelfth aspect of the present invention provides a nonvolatile memory system including a nonvolatile memory device having a nonvolatile memory and a memory controller for reading data from and writing data to the nonvolatile memory and an access device that communicates with the nonvolatile memory device having the nonvolatile memory. The nonvolatile memory system includes the nonvolatile memory device of the eleventh aspect of the present invention, and the access device of one of the first to ninth aspects of the present invention.

### Advantageous Effects

The present invention enables an access device to receive the status of a nonvolatile memory from a nonvolatile memory device and enables data maintenance to be performed in accordance with the status of the nonvolatile memory system, without requiring the data maintenance to be performed together with normal processing of the system. The invention thus enables the maintenance to be performed with a sufficiently long processing time allocated to the maintenance, and improves the data retention properties. The invention also enables the system management status, such as the battery level, to be controlled in a manner that the maintenance will be completed in a reliable manner.

The invention thus enables data maintenance in, for example, portable devices to be performed in a reliable manner.

### BRIEF DESCRIPTION OF DRAWINGS

FIG. 1 is a schematic diagram showing the structure of a nonvolatile memory system 1000 according to a first embodiment of the present invention.

FIG. 2 is a flowchart showing data maintenance request generation performed by a nonvolatile memory module 100.

FIG. 3 is a flowchart showing data maintenance command generation performed by an adaptive command unit 150.

FIG. 4 is a flowchart showing data maintenance performed by the nonvolatile memory module 100.

FIG. 5 is a schematic diagram showing the structure of a nonvolatile memory system 2000 according to a second embodiment of the present invention.

FIG. 6 is a flowchart showing system control notification and data maintenance command generation performed by an adaptive command unit 530.

FIG. 7 is a schematic diagram showing the structure of a nonvolatile memory system 3000 according to a third embodiment of the present invention.

FIG. 8 is a flowchart showing address prioritizing and data maintenance command generation performed by an adaptive command unit 710.

FIG. 9 is a flowchart showing voluntary data maintenance command generation performed by an adaptive command unit 710.

FIG. 10 is a schematic diagram showing the structure of a nonvolatile memory system 4000 according to a fourth embodiment of the present invention.

FIG. 11 is a flowchart showing maintenance need determination and maintenance request generation performed by a nonvolatile memory module 100A.

FIG. 12 is a schematic diagram showing the structure of a nonvolatile memory system 5000 according to a fifth embodiment of the present invention.

FIG. 13 is a flowchart showing data read command generation performed by a command generation unit 1211.

### REFERENCE SIGNS LIST

1000, 2000, 3000, 4000, 5000 nonvolatile memory system
100, 100A nonvolatile memory module (nonvolatile memory system)
110, 1010 memory controller
111 host I/F unit
112 CPU
113 read/write control unit
114 error correction unit
115, 1011 maintenance request unit
120, 1020 nonvolatile memory
130, 500, 700, 1200 access module (access device)
140 system control unit
150, 530, 710, 1210 adaptive command unit
151 system status monitoring unit
152, 531, 711 maintenance determination unit
153, 712 maintenance entry list
154, 1211 command generation unit
520 power supply unit
720, 1220 memory
721, 1021, 1221 data management information storage unit

### DESCRIPTION OF EMBODIMENTS

Embodiments of the present invention will now be described with reference to the drawings. In each of the embodiments, the components or processing parts given the same reference numerals as in the preceding embodiments will not be described.

### First Embodiment

### 1.1 Structure of Nonvolatile Memory System

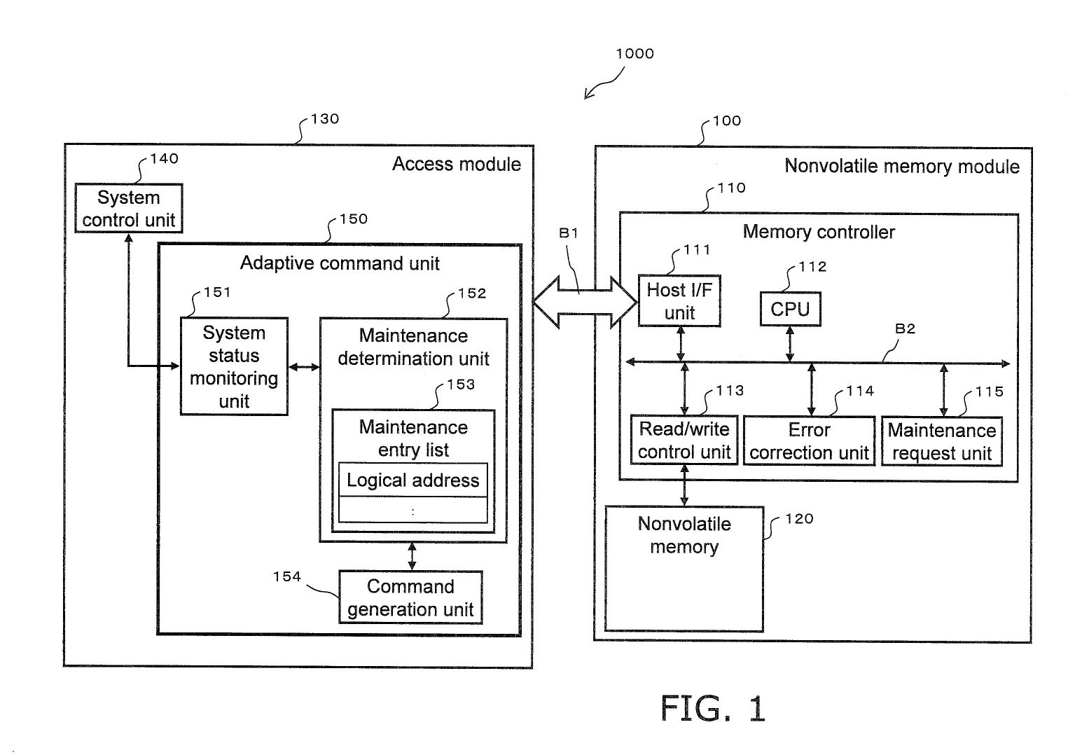

FIG. 1 is a block diagram of a nonvolatile memory system 1000 according to a first embodiment of the present invention.

As shown in FIG. 1, the nonvolatile memory system 1000 of the present embodiment includes a nonvolatile memory module (nonvolatile memory device) 100 and an access module (access device) 130. The nonvolatile memory module 100 and the access module 130 are connected to each other with a bus B1, via which bidirectional data communication can be performed between the modules.

The nonvolatile memory module 100 includes a memory controller 110 and a nonvolatile memory 120.

The access module 130 transmits a command for reading and writing user data (hereafter referred simply as “data”), a logical address, and data to the nonvolatile memory 120 via the bus B1 and the memory controller 110 included in the nonvolatile memory module 100.

### 1.1.1 Internal Structure of Memory Controller 110

The internal structure of the memory controller 110 will now be described.

The memory controller 110 controls the nonvolatile memory module 100. The memory controller 110 includes a host interface unit (host I/F unit) 111, a CPU 112, a read/write control unit 113, an error correction unit 114, and a maintenance request unit 115. These functional units of the memory controller 110 are connected to each other via an internal bus B2 as shown in FIG. 1. The functional units of the memory controller 110 may not necessarily be connected to each other via a bus, but some or all of the functional units may be directly connected to each other.

The host I/F unit 111 receives a data read command, a data write command, or data transmitted from the access module 130 to the nonvolatile memory module 100. Also, the host I/F unit 111 transmits data or the like transmitted from the nonvolatile memory module 100 to the access module 130.

The CPU 112 controls the overall operation of the memory controller 110 using a RAM (not shown) as a workplace or a ROM (not shown) storing programs.

The read/write control unit 113 controls reading of data from and writing of data to the nonvolatile memory 120.

The error correction unit 114 calculates an ECC for data that is written to the nonvolatile memory 120. For data that is read from the nonvolatile memory 120, the error correction unit 114 performs error detection and error correction of the data and also determines the number of errors in the data using an ECC. The functions of the error correction unit 114 may be implemented by the CPU 112 performing software processing.

The maintenance request unit 115 determines whether an area (in units of blocks) in the nonvolatile memory 120 from which data has been read needs maintenance based on the number of errors determined by the error correction unit 114. When determining that the area needs maintenance, the maintenance request unit 115 transmits a maintenance request to the access module 130.

The maintenance request includes a logical address of a block that needs maintenance. The maintenance request is transmitted to the access module 130 via the host I/F unit 111.

### 1.1.2 Internal Structure of Access Module 130

The internal structure of the access module 130 will now be described.

The access module 130 includes a system control unit 140 and an adaptive command unit 150.

The system control unit 140 controls the overall operation of the access module 130 including control associated with the processing caused by commands including a read command and a write command or management of the other system status.

The internal structure of the adaptive command unit 150 will now be described.

The adaptive command unit 150 includes a system status monitoring unit 151, a maintenance determination unit 152, and a command generation unit 154.

The system status monitoring unit 151 monitors the system status of the access module 130 (whether the access module is engaged in data transfer for example), and transmits information about the system status to the maintenance determination unit 152.

The maintenance determination unit 152 stores a logical address included in each maintenance request transmitted from the maintenance request unit 115 in a maintenance entry list 153. When determining that the access module 130 is not engaged in normal processing (initialization, data reading, or data writing) performed with the nonvolatile memory module 100 based on the information about the system status transmitted from the system status monitoring unit 151, the maintenance determination unit 152 determines that the system is enabled to perform maintenance, or in other words the system is in maintenance-enabled status.

In this case, the command generation unit 154 included in the adaptive command unit 150 generates a maintenance command for causing maintenance for data retention, such as refresh, to be performed for an address stored in the maintenance entry list 153. The adaptive command unit 150 then transmits the maintenance command generated by the command generation unit 154 to the nonvolatile memory module 100.

The maintenance command includes a logical address of a block that needs maintenance (hereafter referred to as a “maintenance-needed block”) stored in the maintenance entry list 153. The maintenance command is transmitted to the nonvolatile memory module 100 via the host I/F unit 111.

### 1.2 Operation of Nonvolatile Memory System

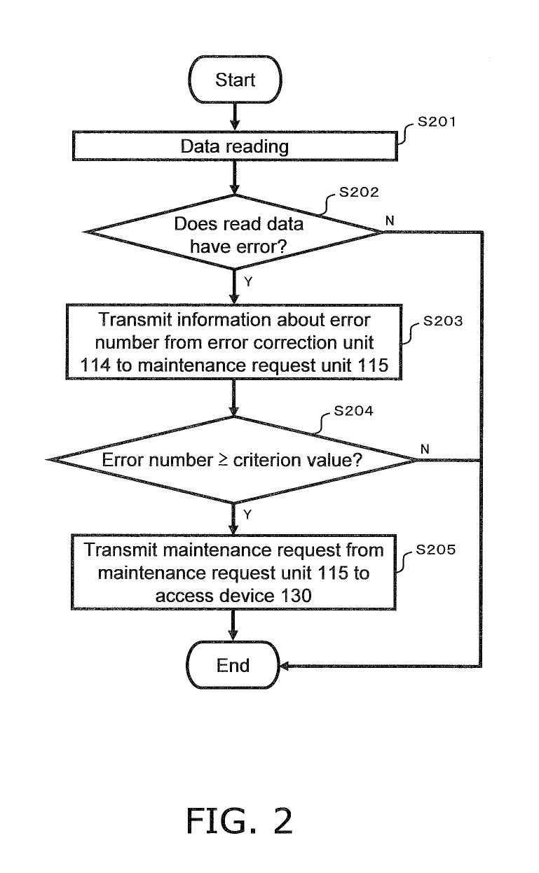

A data maintenance cycle used in the nonvolatile memory system 1000 with the above-described structure will now be described with reference to the flowcharts shown in FIGS. 2 to 4.

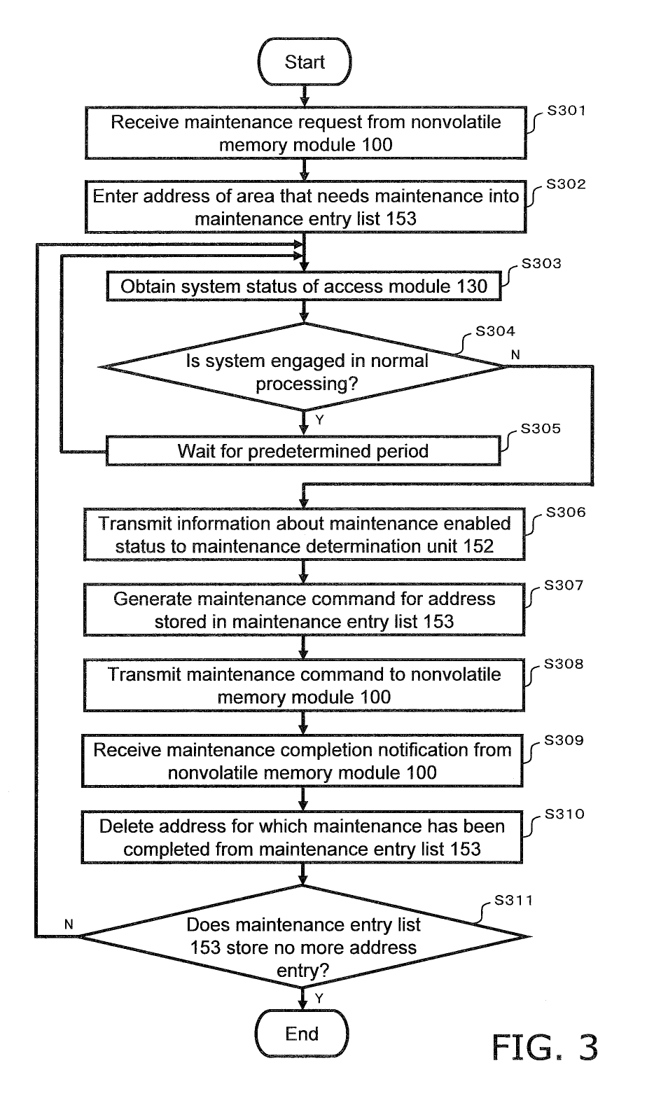

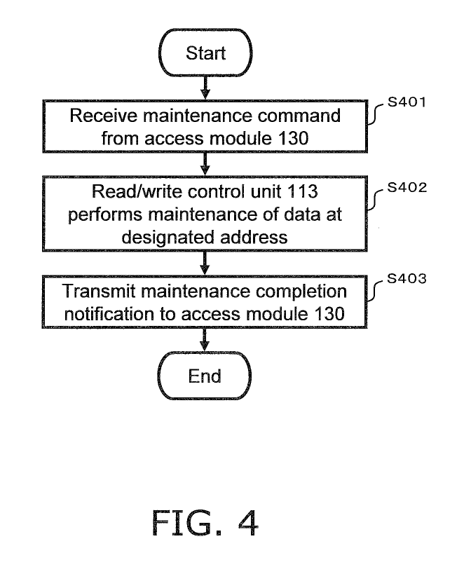

FIG. 2 shows a data maintenance request generation cycle used in the nonvolatile memory module 100. FIG. 3 shows a data maintenance command generation cycle used in the adaptive command unit 150 included in the access module 130. FIG. 4 shows a data maintenance cycle used in the nonvolatile memory module 100.

For ease of explanation, only the operational procedure associated with data maintenance according to the present embodiment will be described.

### 1.2.1 Data Maintenance Request Generation Cycle

### S201:

In the nonvolatile memory system 1000, as shown in FIG. 2, the access module 130 transmits, to the nonvolatile memory module 100, a command for reading valid data including an address (logical address) of data to be read, and then the read/write control unit 113 reads data from a designated address in the nonvolatile memory 120 (a physical address corresponding to the logical address designated by the access module 130) and an ECC associated with the data, and transmits the data and the ECC to the error correction unit 114.

The error correction unit 114 determines whether the read data has an error, and determines the number of errors in the data. When detecting an error in the data, the error correction unit 114 corrects the erroneous data. After completing the error correction, the CPU 112 transmits the data from the error correction unit 114 to the access module 130, and completes the data reading process (S201).

### S202, S203:

When the data reading process is completed in the nonvolatile memory system 1000, the read data is then subjected to determination as to whether the data needs maintenance.

The error correction unit 114 first determines whether the data has an error (S202). When detecting an error, the error correction unit 114 transmits information about the number of errors in the data to the maintenance request unit 115 (S203). When detecting no error, the error correction unit 114 ends the determination as to whether the data needs maintenance.

### S204, S205:

The maintenance request unit 115 determines whether the read area needs maintenance based on the received information about the number of errors in the data. More specifically, the maintenance need determination is performed based on whether the number of errors is greater than or equal to a criterion value (S204). When the number of errors is greater than or equal to the criterion value, the maintenance request unit 115 transmits a maintenance request to the access module 130 (S205), and ends the maintenance need determination. When the number of errors is smaller than the criterion value, the maintenance request unit 115 determines that the data needs no maintenance, and ends the maintenance need determination.

### 1.2.2 Data Maintenance Command Generation Cycle

The procedure performed by the access module 130 when receiving a maintenance request from the nonvolatile memory module 100 until generating a maintenance command will now be described with reference to FIG. 3.

### S301, S302:

When the access module 130 receives a maintenance request from the nonvolatile memory module 100 (S301), the maintenance determination unit 152 enters, into the maintenance entry list 153, a logical address of a block that needs maintenance (maintenance-needed block) included in the maintenance request (S302). It is preferable that the maintenance request transmitted from the nonvolatile memory module 100 to the access module 130 includes information for identifying the maintenance-needed block and information about the processing time for the maintenance that will be required by the nonvolatile memory module 100. The information for identifying the maintenance-needed block may be, for example, a logical address of the maintenance-needed block, or a logical address of the start of the maintenance-needed block and the size of the block, or a logical address of the start of the maintenance-needed block and a logical address of the end of the maintenance-needed block.

### S303 to S305:

When detecting an address stored in the maintenance entry list 153, the system status monitoring unit 151 obtains the system status of the nonvolatile memory system 1000 from the system control unit 140 (S303), and determines whether the system is engaged in normal processing (S304).

When determining that the system is engaged in normal processing, the system status monitoring unit 151 waits for a predetermined period of time (S305), and again obtains the system status (S303).

### S306 to S308:

When determining that the system is not engaged in normal processing, the system status monitoring unit 151 transmits information indicating that the system is in maintenance-enabled status to the maintenance determination unit 152 (S306). The maintenance determination unit 152 then instructs the command generation unit 154 to generate a maintenance command using the address of the maintenance-needed block stored in the maintenance entry list 153. The command generation unit 154 generates and outputs a maintenance command as instructed by the maintenance determination unit 152 (S307).

The adaptive command unit 150 transmits the maintenance command generated by the command generation unit 154 to the nonvolatile memory module 100 (S308).

### S309 to S311:

Subsequently, the access module 130 receives a maintenance completion notification from the nonvolatile memory module 100 (S309). The maintenance determination unit 152 then deletes the address for which maintenance has been completed from the maintenance entry list 153 (S310).

The maintenance determination unit 152 determines whether the maintenance entry list 153 stores another address entry (S311). When detecting no address entry, the maintenance determination unit 152 determines that all maintenance has been completed, and ends the data maintenance command generation cycle. When the maintenance entry list 153 stores an address entry, the processing returns to the step in which the system status is obtained (S303).

### 1.2.3 Data Maintenance Cycle

The procedure performed by the nonvolatile memory module 100 when receiving a maintenance command from the access module 130 until completing the maintenance will now be described with reference to FIG. 4.

### S401 to S403:

When the nonvolatile memory module 100 receives a maintenance command from the access module 130 (S401), the read/write control unit 113 performs maintenance, such as refresh, of data stored at a designated address (logical address) of the nonvolatile memory 120 included in the maintenance command (S402). More specifically, the read/write control unit 113 first converts the designated address (logical address) of the nonvolatile memory 120 included in the maintenance command to a physical address of the nonvolatile memory 120 through logical to physical address conversion. The read/write control unit 113 then performs maintenance, such as refresh, of data stored at the physical address of the nonvolatile memory 120 obtained through the logical to physical address conversion.

After completing the maintenance, the nonvolatile memory module 100 transmits a maintenance completion notification to the access module 130 (S403), and ends the maintenance cycle.

The maintenance completion notification contains a logical address of a block included in the nonvolatile memory 120 for which maintenance has been completed.

In the nonvolatile memory system 1000 of the present embodiment, the criterion value for the number of errors, which is used to determine whether maintenance needs to be performed, is set based on the threshold number of errors that can be corrected by the system, and the criterion value also considers the effect of its setting on the data retention period and the processing speed.

As described above, the nonvolatile memory system 1000 of the present embodiment enables the maintenance to be performed with a sufficiently long processing time allocated to the maintenance, without requiring the maintenance to be performed together with normal processing of the system, and reduces the risk of data loss and improves the data retention properties.

The number of errors may be defined in units of bits or may be defined in units of symbols each of which consists of a plurality of bits.

The system status monitoring unit 151 may obtain the system status. Alternatively, the information about the system status may be provided from the system control unit 140 to the adaptive command unit 150.

The maintenance request may include a plurality of logical addresses of a plurality of blocks instead of including only a single address of a single block. In this case, information indicating whether an area that needs maintenance consists of a single block or consists of a plurality of blocks may also be entered into the maintenance entry list 153 when the corresponding address is entered into the maintenance entry list 153.

A single maintenance command may be generated for a plurality of addresses of a plurality of blocks in the nonvolatile memory system 1000, instead of being generated for a single block address.

The maintenance may be performed for a plurality of logical blocks at a time, instead of being performed for a single block address at a time.

When the nonvolatile memory system 1000 includes a plurality of nonvolatile memory modules 100 to which the access module 130 is connected, the maintenance determination unit 152 may include a plurality of maintenance entry lists 153 corresponding in one-to-one to the plurality of nonvolatile memory modules 100. In this case, for example, the plurality of nonvolatile memory modules 100 may be given unique IDs (identifiers). The maintenance determination unit 152 may then manage the maintenance entry lists 153 using the IDs (identifiers) of the nonvolatile memory modules 100. This enables the single access module 130 to manage the plurality of nonvolatile memory modules 100.

### Second Embodiment

### 2.1 Structure of Nonvolatile Memory System

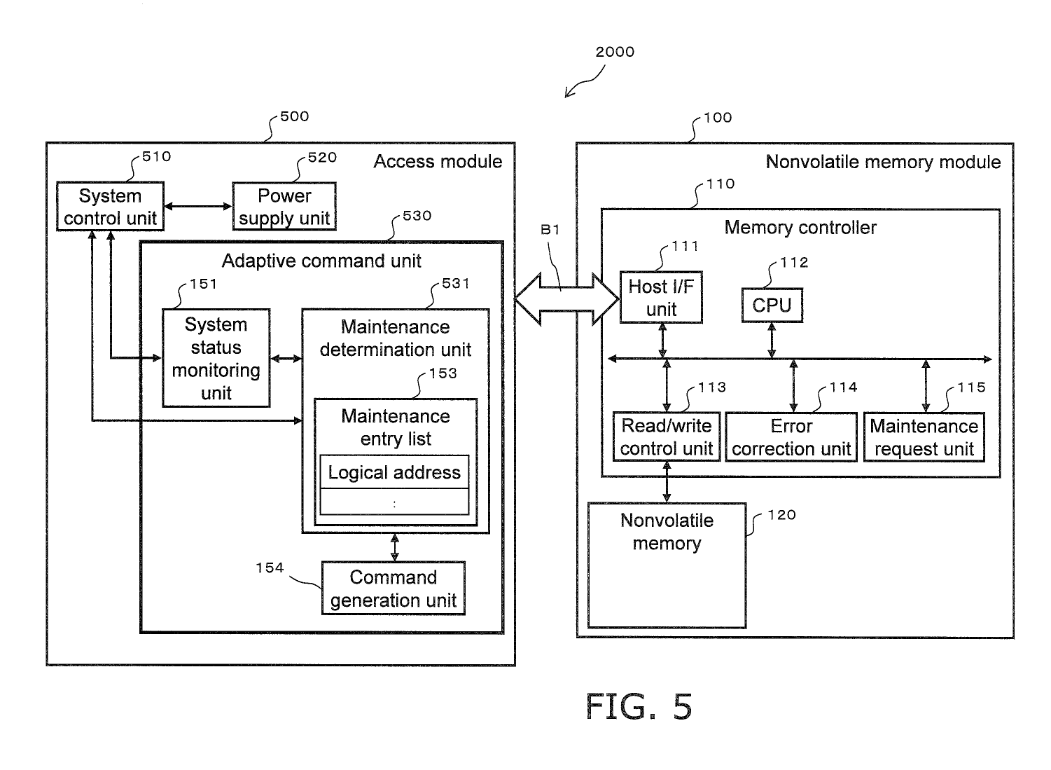

FIG. 5 is a block diagram of a nonvolatile memory system 2000 according to a second embodiment of the present invention.

As shown in FIG. 5, the nonvolatile memory system 2000 includes a nonvolatile memory module (nonvolatile memory device) 100 and an access module (access device) 500. The nonvolatile memory module 100 and the access module 500 are connected to each other with a bus B1, via which bidirectional data communication can be performed between the modules.

In the present embodiment, the components that are the same as the components in the first embodiment are given the same reference numerals as in FIG. 1, and will not be described.

The nonvolatile memory module 100 has the same structure as in the first embodiment. The access module 500 includes a system control unit 510, a power supply unit 520, and an adaptive command unit 530.

The power supply unit 520 supplies power not only to the access module 500 but also to the nonvolatile memory module 100.

The system control unit 510 controls the overall operation of the access module 500 including control associated with the processing caused by commands including a read command and a write command, management of the power supply of the power supply unit 520, and management of the other system status.

The part of the adaptive command unit 530 different from the adaptive command unit in the first embodiment will now be described.

The adaptive command unit 530 includes a maintenance determination unit 531.

In addition to the functions of the maintenance determination unit 152 of the first embodiment, the maintenance determination unit 531 further determines the number of times maintenance needs to be performed based on the number of addresses stored in the maintenance entry list 153 when the maintenance entry list 153 is updated, and transmits information about the number of times maintenance needs to be performed to the system control unit 510.

### 2.2 Operation of Nonvolatile Memory System

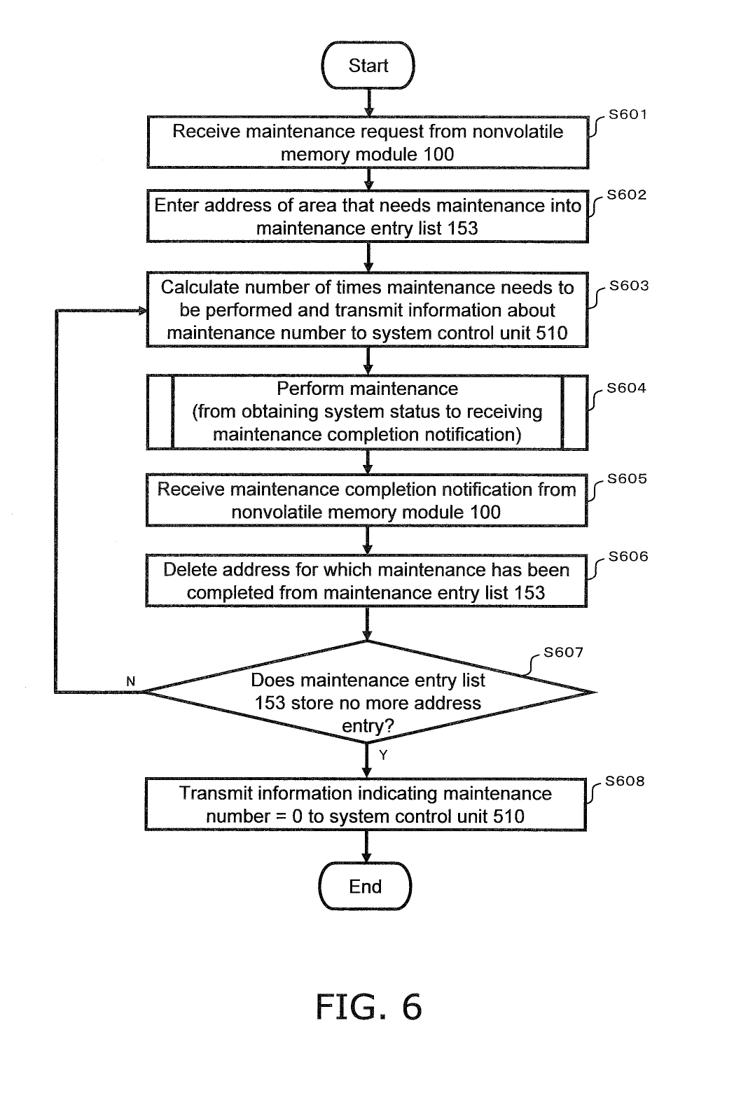

A data maintenance cycle used in the nonvolatile memory system 2000 with the above-described structure will now be described with reference to the flowchart shown in FIG. 6.

FIG. 6 shows a data maintenance command generation cycle used in the adaptive command unit 530 included in the access module 500. For simplification, the processing part that is the same as the processing of the first embodiment will not be described.

### 2.2.1 Data Maintenance Request Generation Cycle

### S601, S602:

In the nonvolatile memory system 2000, as shown in FIG. 6, the access module 500 first receives a maintenance request from the nonvolatile memory module 100 (S601). The maintenance determination unit 531 then enters a logical address of a maintenance-needed block into the maintenance entry list 153 (S602).

### S603:

The maintenance determination unit 531 determines the number of times maintenance needs to be performed based on the number of addresses stored in the maintenance entry list 153, and transmits information about the determined number of times to the system control unit 510 (S603).

The system control unit 510 then determines a minimum battery level that will be required for the maintenance processing corresponding to the determined number of times based on the transmitted information about the number of times maintenance needs to be performed, and manages the power supply unit 520 as well as the entire system to reserve the required battery level.

### S604:

The maintenance is then performed (S604). The processing in step S604 is the same as the processing in steps S303 to S308 in FIG. 3 described in the first embodiment.

### S605 to S608:

When the maintenance is completed and the access module 500 receives a maintenance completion notification from the nonvolatile memory module 100 (S605), the maintenance determination unit 531 deletes the address for which the maintenance has been completed from the maintenance entry list 153 (S606).

The maintenance determination unit 531 determines whether the maintenance entry list 153 stores another address entry (S607). When detecting no address entry, the maintenance determination unit 531 determines that all maintenance has been completed, and transmits information indicating that the number of times maintenance needs to be performed is zero to the system control unit 510 (S608).

When receiving the information indicating that the number of times maintenance needs to be performed is zero, the system control unit 510 releases the system limitations including the reserved battery level. No more maintenance needs to be performed in this state. The system control unit 510 may control the nonvolatile memory system 2000, which has been operating in, for example, the power saving mode to reserve the required battery level, to operate in the normal mode (mode that is not the power saving mode).

When the maintenance entry list 153 stores an address entry in step S607, the processing returns to the step in which information about the number of times maintenance needs to be performed is transmitted (S603).

As described above, the nonvolatile memory system 2000 of the present embodiment executes the system control in accordance with the maintenance status, and executes the system control in a manner that all the needed maintenance processing will be completed in a reliable manner by, for example, reserving the required battery level in advance. As a result, the nonvolatile memory system 2000 enhances the data retention properties.

The number of times the maintenance needs to be performed, which is determined by the maintenance determination unit 531, may be simply equal to the number of address entries stored in the list, or may be determined as the number of times the maintenance is to be performed when a single maintenance command is generated for a plurality of block addresses.

The required battery level to be reserved, which is determined by the system control unit 510, may be calculated based on the type of the nonvolatile memory used in the nonvolatile memory module 100 connected to the access module 500 or based on the block length setting of the nonvolatile memory. Alternatively, the system control unit 510 may calculate and store information about the power consumption required per maintenance in advance, and may determine the required battery level based on the information about the power consumption required per maintenance.

The system control unit 510 may use a different condition for switching the system mode to the power saving mode to reserve the required battery level. More specifically, the system control unit 510 may use, for example, the condition for switching to the power saving mode when the battery level decreases to or below X2% (X2>X12), instead of using the condition for switching to the power saving mode when the battery level decreases to or below X1%. The use of such a condition provides a larger margin against the possibility that the battery level will reach zero. This enables the maintenance to be performed in a more reliable manner (reduces the risk of the battery level reaching zero and forcing the system to shut down during the maintenance processing). Additionally, when the access module 500 includes a display unit, the system control unit 510 may change the battery level display on the display unit in a manner to urge the user to supply power to the module.

Additionally, the system control unit 510 may control all the needed maintenance processing to be completed with priority over normal processing of the system when determining that the battery level decreases and approaches the required battery level.

### Third Embodiment

### 3.1 Structure of Nonvolatile Memory System

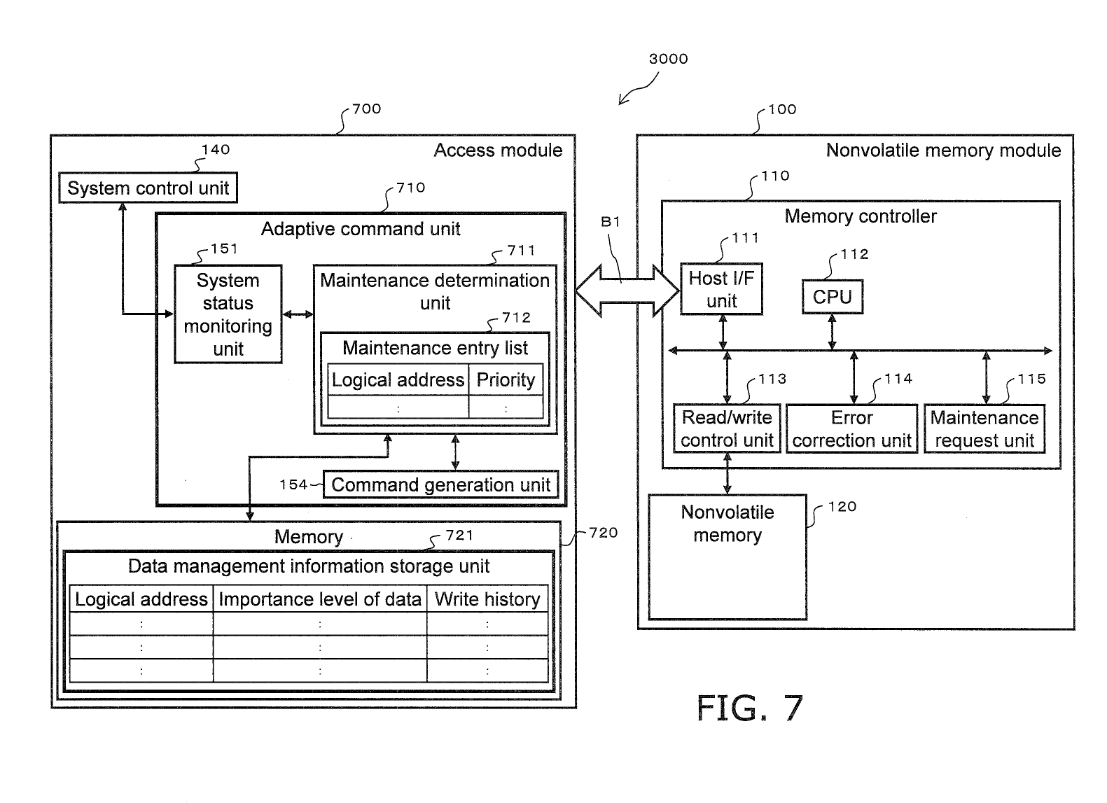

FIG. 7 is a block diagram of a nonvolatile memory system 3000 according to a third embodiment of the present invention.

As shown in FIG. 7, the nonvolatile memory system 3000 of the present embodiment includes a nonvolatile memory module (nonvolatile memory device) 100 and an access module (access device) 700. The nonvolatile memory module 100 and the access module 700 are connected to each other with a bus B1, via which bidirectional data communication can be performed between the modules.

In the present embodiment, the components that are the same as the components in the first embodiment are given the same reference numerals as in FIG. 1, and will not be described.

The nonvolatile memory module 100 has the same structure as in the first embodiment.

The access module 700 includes a system control unit 140, an adaptive command unit 710, and a memory 720.

The memory 720 includes a data management information storage unit 721.

The data management information storage unit 721 may store, together with the addresses, the importance levels of data stored in the nonvolatile memory 120 and the write history of data in the nonvolatile memory 120 (information about the time at which the data has been written). The information stored in the data management information storage unit 721 is updated when the access module 700 writes data to the nonvolatile memory 120.

The part of the adaptive command unit 710 different from the adaptive command unit in the first embodiment will be described.

The adaptive command unit 710 includes a maintenance determination unit 711.

In addition to the functions of the maintenance determination unit 152 of the first embodiment, the maintenance determination unit 711 further enters the priorities for the plurality of addresses stored in the maintenance entry list 712. The priorities added to the addresses are used when the maintenance is performed for each of the addresses. The addresses having higher priorities are processed earlier. The adaptive command unit 710 prioritizes the addresses by referring to information about the importance levels of data stored in the data management information storage unit 721. The adaptive command unit 710 generates a maintenance command in a manner that the addresses (logical addresses) are processed sequentially from an address having a higher priority in the maintenance entry list 712.

### 3.2. Operation of Nonvolatile Memory System

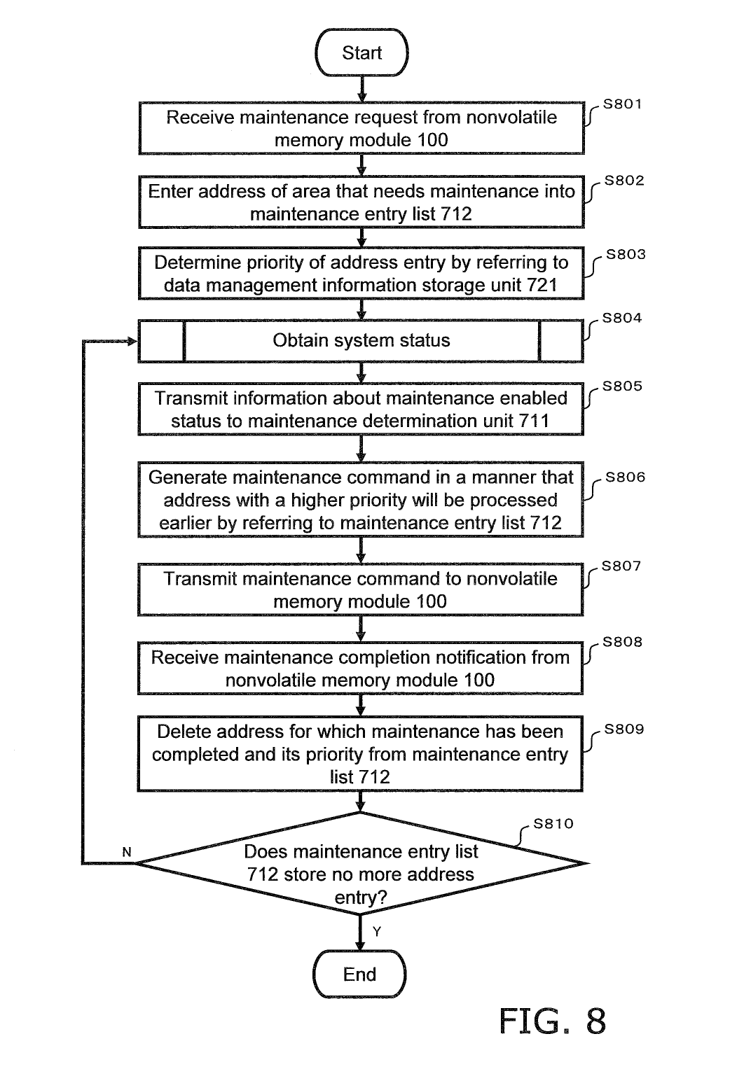

A data maintenance cycle used in the nonvolatile memory system 3000 with the above-described structure will now be described with reference to the flowchart shown in FIG. 8.

### 3.2.1 Data Maintenance Cycle 1

FIG. 8 shows a data maintenance command generation cycle used in the adaptive command unit 710 included in the access module 700. For simplification, the processing part that is the same as the processing of the first embodiment will not be described. The data management information storage unit 721 stores information about, for example, the importance levels of data entered when the data is written to the nonvolatile memory 120.

### S801 to S803:

In the nonvolatile memory system 3000, as shown in FIG. 8, the access module 700 first receives a maintenance request from the nonvolatile memory module (S801). The maintenance determination unit 711 then enters a logical address of a block that needs maintenance (maintenance-needed block) into the maintenance entry list 712 (S802). When entering the address, the maintenance determination unit 711 refers to information about, for example, the importance level of the data stored in the data management information storage unit 721, and adds a priority with which maintenance is to be performed to the address entry (S803).

For example, the maintenance determination unit 711 may obtain the importance level of data corresponding to the address entry from the data management information storage unit 721. When the obtained importance level is high, the maintenance determination unit 711 may add a high priority to the address entry.

### S804:

Subsequently, the system status is obtained (S804). The processing in step S804 is the same as the processing in steps S303 to S305 in FIG. 3 described in the first embodiment.

### S805 to S807:

When the system status is other than the status in which normal processing is performed, the system status monitoring unit 151 transmits information indicating that the system is enabled to perform maintenance, or in maintenance-enabled status, to the maintenance determination unit 711 (S805). The maintenance determination unit 711 then instructs the command generation unit 154 to generate a maintenance command for an address of a maintenance-needed block having a higher priority stored in the maintenance entry list 712. The command generation unit 154 generates and outputs a maintenance command as instructed by the maintenance determination unit 711 (S806). The adaptive command unit 710 then transmits the maintenance command generated by the command generation unit 154 to the nonvolatile memory module 100 (S807).

### S808 to S810:

When the access module 700 receives a maintenance completion notification from the nonvolatile memory module 100 (S808), the maintenance determination unit 711 deletes the address for which the maintenance has been completed and its priority from the maintenance entry list 712 (S809).

The maintenance determination unit 711 determines whether the maintenance entry list 712 stores another address entry (S810). When detecting no address entry, the maintenance determination unit 711 determines that all maintenance has been completed, and ends the data maintenance command generation cycle. When the maintenance entry list 712 stores an address entry, the processing returns to the step in which the system status is obtained (S804).

### 3.2.1 Data Maintenance Cycle 2

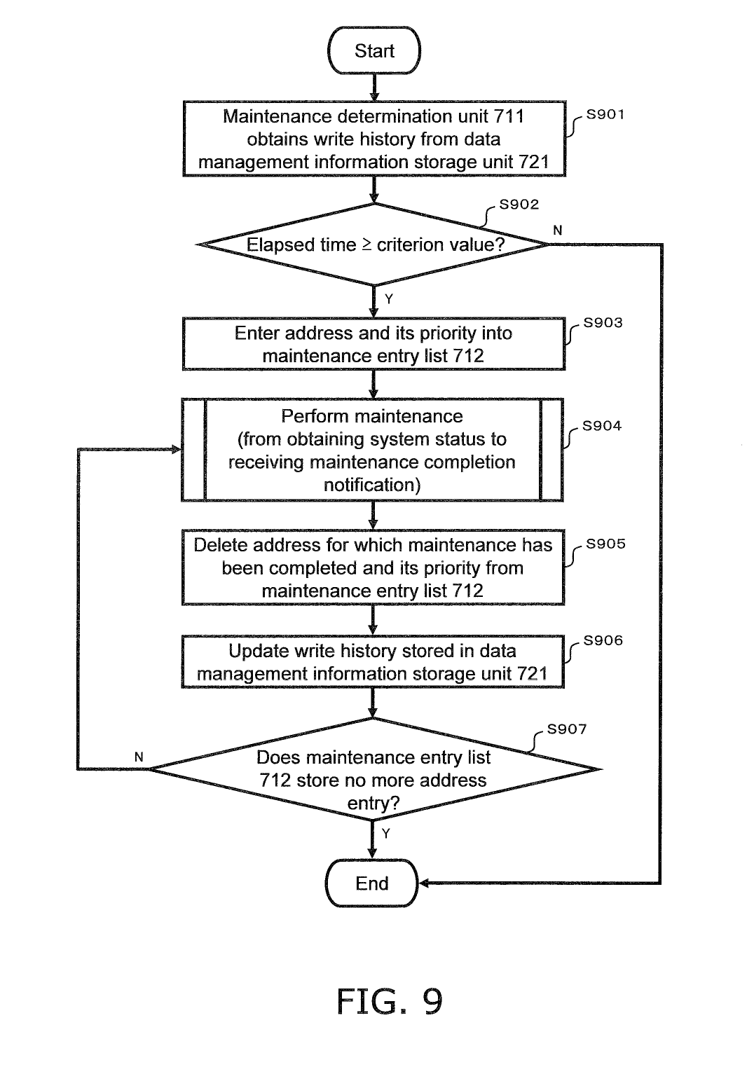

Another data maintenance cycle used in the nonvolatile memory system 3000 of the present embodiment will now be described with reference to a flowchart shown in FIG. 9. For simplification, the processing part that is the same as the processing for the data maintenance cycle described above in the present embodiment will not be described.

### S901:

In the nonvolatile memory system 3000, as shown in FIG. 9, the maintenance determination unit 711 first obtains the write history stored in the data management information storage unit 721 (information about the time at which data has been previously written to the address) (S901).

### S902, S903:

The maintenance determination unit 711 calculates the elapsed time from when the data has been written previously based on the write history, and determines whether the elapsed time is greater than or equal to a criterion value for determining the data retention (S902). When determining that the elapsed time is greater than or equal to the criterion value, the maintenance determination unit 711 enters the address and its priority into the maintenance entry list 712 (S903).

The criterion value is set based on the data retention properties of the nonvolatile memory 120. The nonvolatile memory module 100 and the access module 700 exchange their device information including the data retention properties with each other when, for example, the system is initialized. As a result, the access module 700 obtains and stores the set criterion value in advance.

### S904 to S907:

Subsequently, the maintenance is performed in the nonvolatile memory system 3000. The access module 700 receives a maintenance completion notification from the nonvolatile memory module 100 (S904). The maintenance determination unit 711 then deletes the address for which the maintenance has been completed and its priority from the maintenance entry list 712 (S905), and further updates the write history stored in the data management information storage unit 721 (S906).

The maintenance determination unit 711 determines whether the maintenance entry list 712 stores another address entry (S907). When detecting no address entry, the maintenance determination unit 711 determines that all maintenance has been completed, and ends the data maintenance command generation cycle. When the maintenance entry list 712 stores an address entry, the processing returns to the step in which the system status is obtained (S904).

In the nonvolatile memory system 3000 of the present embodiment described above, the access module 700 manages the logical addresses of important data, and prioritizes the addresses in a manner that more important data will be processed earlier. This enables important data to be retained in a more reliable manner.

In the nonvolatile memory system 3000, the access module 700 further manages the write history of data for each logical address, and voluntarily performs maintenance of data that has been left unread for a long period of time after the data has been written, without receiving a maintenance request from the nonvolatile memory module 100. This reduces the risk of data loss occurring in an area of the nonvolatile memory 120 from which data has not been read for a long period of time.

The importance level of data may be indicated by using a flag set for only important data, or by using one of a plurality of importance levels set for important data.

The importance level of data may be set for each address of a single block, or may be set for a plurality of logical addresses of a plurality of blocks.

The priorities with which maintenance is to be performed may not be stored in the maintenance entry list 712, but the information about the priorities stored in the data management information storage unit 721 may be referred to every time when maintenance is performed.

The importance level of data and the write history may not necessarily be stored for all data, but may be stored only for specific types of data or for data written in specific areas.

### Fourth Embodiment

### 4.1 Structure of Nonvolatile Memory System

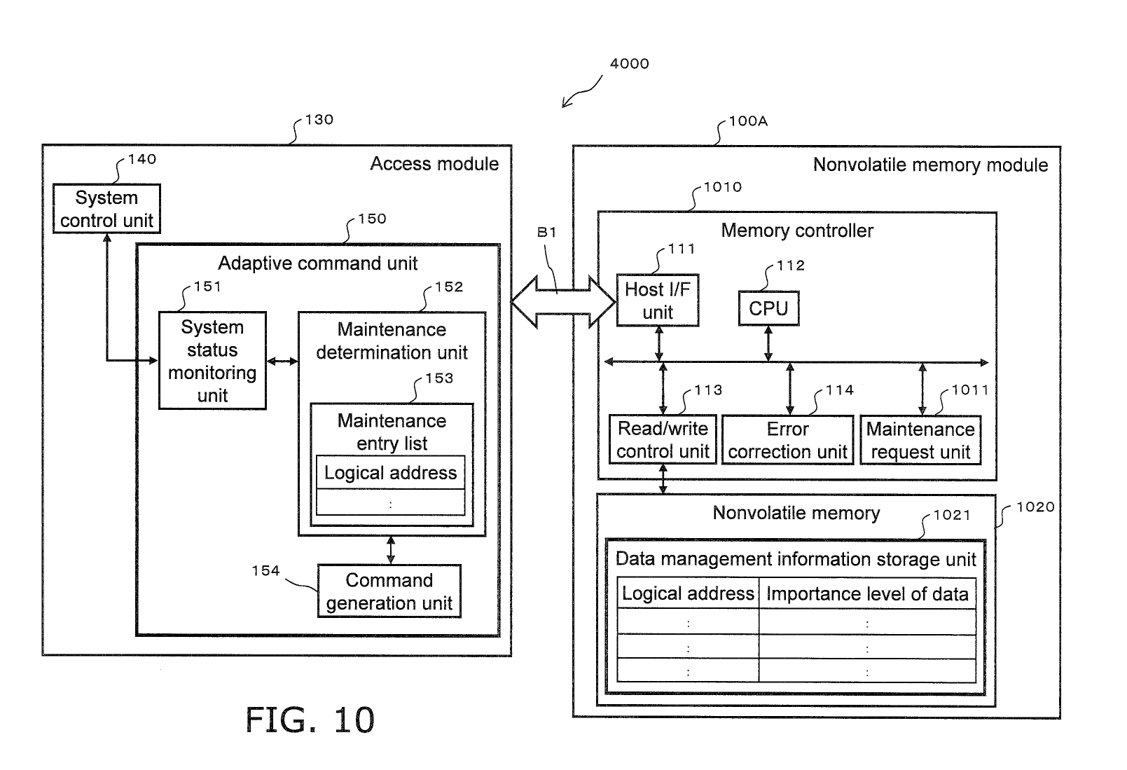

FIG. 10 is a block diagram of a nonvolatile memory system 4000 according to a fourth embodiment of the present invention.

As shown in FIG. 10, the nonvolatile memory system 4000 of the present embodiment includes a nonvolatile memory module (nonvolatile memory device) 100A and an access module (access device) 130. The nonvolatile memory module 100A and the access module 130 are connected to each other with a bus B1, via which bidirectional data communication can be performed between the modules.

In the present embodiment, the components that are the same as the components in the first embodiment are given the same reference numerals as in FIG. 1, and will not be described.

The access module 130 has the same structure as in the first embodiment.

The nonvolatile memory module 100A includes a memory controller 1010 and a nonvolatile memory 1020.

The nonvolatile memory 1020 includes a data management information storage unit 1021 in the same manner as the memory 720 described in the third embodiment.

The data management information storage unit 1021 stores, together with the addresses, the priorities of data stored in the nonvolatile memory 120 and other information. The information stored in the data management information storage unit 1021 is written together with data when the access module 130 writes the data to the nonvolatile memory 120.

The part of the memory controller 1010 different from the memory controller in the first embodiment will now be described.

The memory controller 1010 includes a maintenance request unit 1011.

In addition to the functions of the maintenance request unit 115 of the first embodiment, the maintenance request unit 1011 further refers to information about the importance level of data stored in the data management information storage unit 1021 when determining whether the read data needs maintenance, and dynamically changes the criterion of determination as to whether the data needs maintenance based on the information about the importance level of data.

### 4.2 Operation of Nonvolatile Memory System

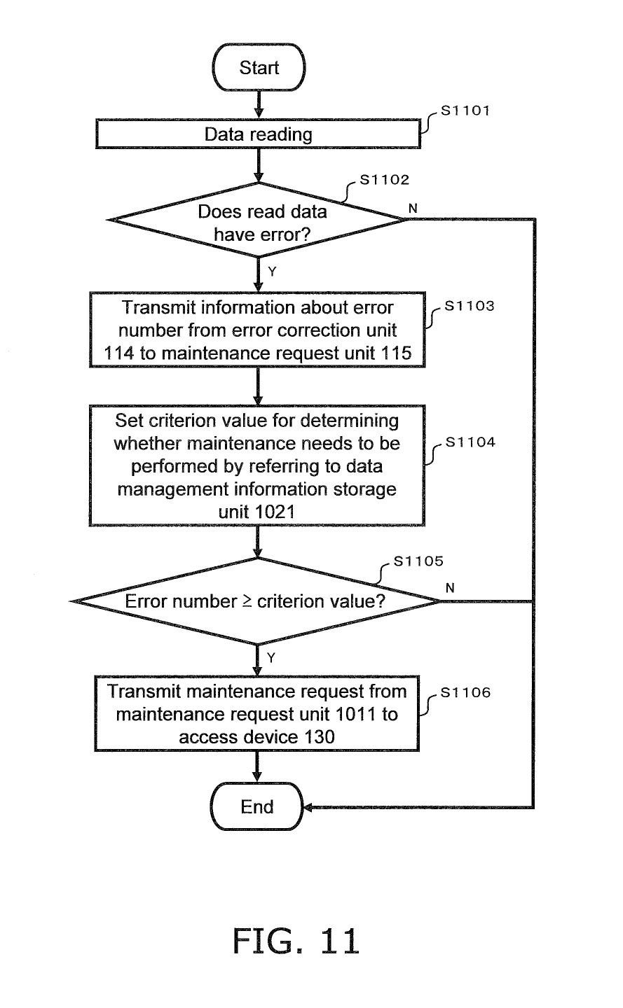

A data maintenance request generation cycle used in the nonvolatile memory system 4000 with the above-described structure will now be described with reference to the flowchart shown in FIG. 11.

4.2.1 Data Maintenance Request Generation cycle

FIG. 11 shows a data maintenance request generation cycle used in the nonvolatile memory module 100A. For simplification, the processing part that is the same as the processing of the above embodiments will not be described.

### S1101 to S1103:

In the nonvolatile memory system 4000, as shown in FIG. 11, the processing from the reading of data (S1101) to the notification of the number of data errors (S1103) is the same as in the first embodiment.

### S1104:

The maintenance request unit 1011 receives information about the number of errors from the error correction unit 114, and then obtains the importance level of data that has been read by referring to the data management information storage unit 1021 and sets the criterion value used to determine whether the data needs maintenance in accordance with the obtained importance level (S1104).

### S1105, S1106:

Subsequently, the maintenance request unit 1011 determines whether maintenance needs to be performed based on whether the number of errors is greater than or equal to the criterion value (S1105). When the number of errors is greater than or equal to the criterion value, the maintenance request unit 1011 transmits a maintenance request to the access module 130 (S1106), and ends the determination as to whether maintenance needs to be performed. When the number of errors is below the criterion value, the maintenance request unit 1011 determines that no maintenance needs to be performed, and ends the maintenance need determination.

As described above, the nonvolatile memory system 4000 of the present embodiment dynamically changes the criterion value used to determine whether maintenance needs to be performed based on the importance level of data. This enables a maintenance request to be generated in a manner to provide a sufficient margin only for important data against the possibility that the number of its errors will reach the threshold number of errors that can be corrected by the system, and thus improves the data retention properties in an efficient manner.

In the nonvolatile memory system 4000, the nonvolatile memory 1020 stores management information including the information about the importance level of data to enable the management information to be shared between different access modules. This prevents loss of important data and enables the important data to be retained in a more reliable manner. The access module 130 stores the latest data management information into the nonvolatile memory 1020 when, for example, the system is powered off. The access module 130 reads the data management information from the nonvolatile memory 120 when the system is initialized.

The importance level of data may be indicated by using a flag set for only important data, or by using one of a plurality of importance levels set for importance data.

The importance level of data may be set for each address of a single block, or may be set for a plurality of logical addresses of a plurality of blocks.

The criterion value used to determine whether maintenance needs to be performed may be set using binary information either indicating that the data is important or that the data is not important, or alternatively may be set using one of a plurality of criterion values determined in accordance with the priorities of data. It is preferable that the criterion value is set to prevent maintenance from being performed even for important data when unnecessary.

The importance level of data may not be stored for all data, but may be stored only for specific types of data or for data written in specific areas.

### Fifth Embodiment

### 5.1 Structure of Nonvolatile Memory System

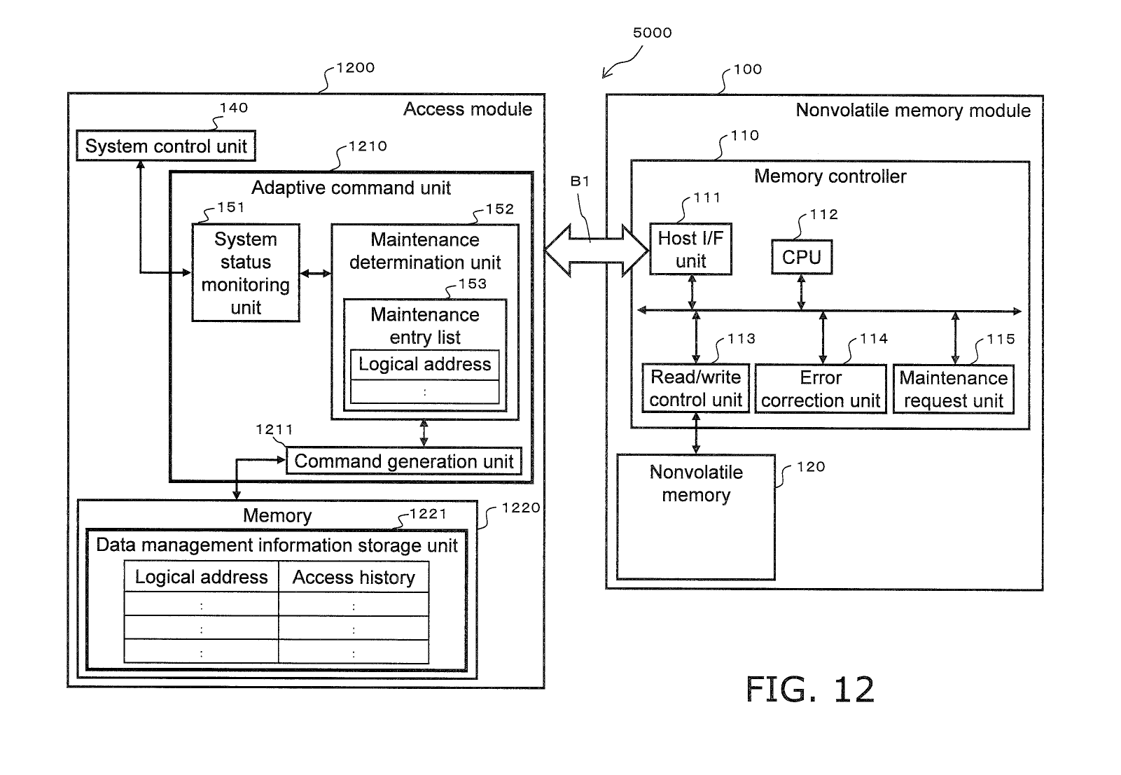

FIG. 12 is a block diagram of a nonvolatile memory system 5000 according to a fifth embodiment of the present invention.

As shown in FIG. 12, the nonvolatile memory system 5000 of the present embodiment includes a nonvolatile memory module (nonvolatile memory device) 100 and an access module (access device) 1200. The nonvolatile memory module 100 and the access module 1200 are connected to each other with a bus B1, via which bidirectional data communication can be performed between the modules.

In the present embodiment, the components that are the same as the components in the first embodiment are given the same reference numerals as in FIG. 1, and will not be described.

The nonvolatile memory module 100 has the same structure as in the first embodiment.

The access module 1200 includes an adaptive command unit 1210 and a memory 1220.

The memory 1220 includes a data management information storage unit 1221.

The data management information storage unit 1221 stores, together with the addresses, the access history of the nonvolatile memory 120 (information about the time at which data has been read from or written to the memory) and other information. The information stored in the data management information storage unit 1221 is updated when the access module 1200 reads the data from or writes the data to the nonvolatile memory 120.

The part of the adaptive command unit 1210 different from the adaptive command unit in the first embodiment will now be described.

The adaptive command unit 1210 includes a command generation unit 1211.

In addition to the functions of the command generation unit 154 of the first embodiment, the command generation unit 1211 further performs the processing described below. The command generation unit 1211 refers to the access history stored in the data management information storage unit 1221, and detects an area from which or to which no data has been read or written for a long period of time, and generates a command for reading data from the detected area (area from which or to which no data has been read or written for a long period of time). This command causes the nonvolatile memory module 100 to perform the data maintenance request generation cycle shown in FIG. 2 to determine whether the area that has not been accessed for a long period of time includes an area that needs maintenance.

### 5.2 Operation of Nonvolatile Memory System

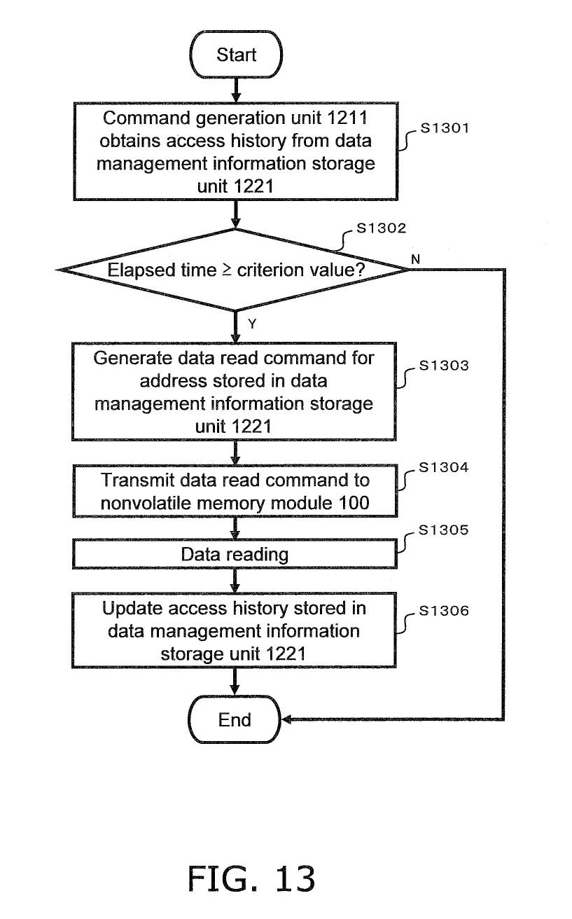

A data read cycle used in the nonvolatile memory system 5000 with the above-described structure will now be described with reference to the flowchart shown in FIG. 13.

### 5.2.1 Data Read Cycle

FIG. 13 shows a data read command generation cycle used in the command generation unit 1211 included in the access module 1200.

### S1301:

In the nonvolatile memory system 5000, as shown in FIG. 13, the command generation unit 1211 first obtains the access history stored in the data management information storage unit 1221 (information about the time at which data has been previously written or read at the address) (S1301).

### S1302, S1303:

The command generation unit 1211 calculates the elapsed time from when the data has been written or read previously based on the access history, and determines whether the elapsed time is greater than or equal to a criterion value for determining the data retention (S1302). When determining that the elapsed time is greater than or equal to the criterion value, the command generation unit 1211 generates a data read command for reading data from the address (S1303), and transmits the generated data read command to the nonvolatile memory module 100 (S1304).

The criterion value is set based on the data retention properties of the nonvolatile memory 120. The nonvolatile memory module 100 and the access module 1200 exchange their device information including the data retention properties with each other when, for example, the system is initialized. As a result, the access module 1200 obtains and stores the set criterion value in advance.

### S1305 to S1306:

In the nonvolatile memory system 5000, the data reading process is performed subsequently (S1305). When the data reading process is completed, the command generation unit 1211 updates the access history of the address from which the data has been read in the address data management information storage unit 1221 (S1306).

In the nonvolatile memory system 5000 of the present embodiment described above, the access module 1200 manages the access history of data in the nonvolatile memory 120 for each logical address. When detecting an area that has not been accessed for a long period of time, the access module 1200 generates a read command for the detected area (a read command for reading data from the detected area). The nonvolatile memory system 5000 determines whether the nonvolatile memory module 100 includes an area that has not been accessed for a long period of time and that needs maintenance. This reduces the risk of data loss occurring in such an area that has not been accessed for a long period of time.

In the nonvolatile memory system 5000, the access history may not necessarily be stored for all data, but may be stored only for specific types of data or for data in specific areas.

In the nonvolatile memory system 5000, the single data read command may be generated for reading data from a single address of a single block, or for reading data from a plurality of logical addresses of a plurality of blocks.

### Other Embodiments

Each block of the nonvolatile memory system, the nonvolatile memory module, and the access module described in the above embodiments may be formed using a single chip with a semiconductor device, such as LSI (large-scale integration), or some or all of the blocks of the nonvolatile memory system, the nonvolatile memory module, and the access module may be formed using a single chip.

Although LSI is used as the semiconductor device technology, the technology may be IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks. Biotechnology is potentially applicable.

The processes described in the above embodiments may be implemented using either hardware or software, or may be implemented using both software and hardware.

The specific structures described in the above embodiment are mere examples of the present invention, and may be changed and modified variously without departing from the scope and spirit of the invention.

### INDUSTRIAL APPLICABILITY

The nonvolatile memory system of the present invention prevents data loss that can occur in a nonvolatile memory whose data retention period can be shortened by the trend toward multivalued flash memories.

The present invention is applicable not only to a semiconductor memory card, but also to, for example, a still image recording/playback apparatus, a moving image recording/playback apparatus, and a portable information terminal including a nonvolatile memory.

1. An access device that accesses a nonvolatile memory device including a nonvolatile memory, the access device comprising:
an adaptive command unit that determines whether data stored in the nonvolatile memory needs maintenance based on a data retention status of the nonvolatile memory obtained from the nonvolatile memory device, and determines whether maintenance is to be performed based on whether the access device is in a system status in which maintenance is enabled and based on whether the data stored in the nonvolatile memory needs maintenance, and generates a maintenance command to the nonvolatile memory device when determining that the maintenance is to be performed.

2. The access device according to claim 1, wherein
the adaptive command unit includes
a system status monitoring unit that monitors the system status of the access device,
a maintenance determination unit that determines whether the maintenance is to be performed based on a monitoring result obtained by the system status monitoring unit and based on whether the data stored in the nonvolatile memory needs maintenance, and
a command generation unit that generates a maintenance command to the nonvolatile memory device in accordance with a determination result obtained by the maintenance determination unit.

3. The access device according to claim 2, wherein
the system status monitoring unit monitors a processing status of the access device, and provides information indicating that maintenance is enabled when determining that the access device is not engaged in normal processing,
the maintenance determination unit determines that the maintenance is to be performed when determining that the data stored in the nonvolatile memory needs maintenance and further receiving from the system status monitoring unit the information indicating that maintenance is enabled, and
the command generation unit generates a maintenance command to the nonvolatile memory device when the maintenance determination unit determines that the maintenance is to be performed.

4. The access device according to claim 2, wherein
the maintenance determination unit stores at least one address of the nonvolatile memory that needs maintenance, and selects an address for which the maintenance is to be performed from the at least one address when receiving from the system status monitoring unit information indicating that maintenance is enabled, and
the command generation unit generates a maintenance command for performing maintenance for the address of the nonvolatile memory device selected by the maintenance determination unit.

5. The access device according to claim 2, further comprising:
a system control unit that executes system control of the access device,
wherein the maintenance determination unit stores at least one address of the nonvolatile memory that needs maintenance, and provides information about the at least one address of the nonvolatile memory to the system control unit.

6. The access device according to claim 5, further comprising:
a power supply unit that supplies power to the access device,
wherein the system control unit determines a minimum battery level to be reserved by the power supply unit based on the information about the at least one address of the nonvolatile memory, and controls the power supply unit and the access device in a manner to reserve the determined minimum battery level.

7. The access device according to claim 4, further comprising:
a data management information storage unit storing data management information for managing data stored in the nonvolatile memory,
wherein the maintenance determination unit changes an order in which maintenance is to be performed for the at least one address in accordance with a status of data stored in the nonvolatile memory by referring to the information stored in the data management information storage unit.

8. The access device according to claim 4, further comprising:
a data management information storage unit storing data management information for managing data stored in the nonvolatile memory,
wherein the maintenance determination unit voluntarily determines and stores an address for which maintenance needs to be performed in accordance with a status of data stored in the nonvolatile memory by referring to the information stored in the data management information storage unit without receiving information about the status of data stored in the nonvolatile memory from the nonvolatile memory device.

9. The access device according to claim 1, wherein
the maintenance includes refresh and/or wear leveling of the nonvolatile memory.

10. A memory controller used in a nonvolatile memory device that reads and/or writes data in accordance with a command provided from an access device for reading data from and writing data to a nonvolatile memory included in the nonvolatile memory device, the memory controller comprising:
an error correction unit that determines the number of errors included in data read from the nonvolatile memory, and corrects an error included in the read data; and
a maintenance request unit that generates a maintenance request indicating that the nonvolatile memory needs maintenance to the access device when the number of errors determined by the error correction unit is greater than or equal to a criterion value,
wherein the maintenance request unit dynamically changes the criterion value used to determine whether to generate a maintenance request in accordance with a status of data stored in the nonvolatile memory, and
the maintenance includes refresh and/or wear leveling of the nonvolatile memory.

11. A nonvolatile memory device for reading and/or writing data in accordance with a command provided from an access device, the nonvolatile memory device comprising:
a nonvolatile memory storing data; and
the memory controller according to claim 10.

12. A nonvolatile memory system including a nonvolatile memory device having a nonvolatile memory and a memory controller for reading data from and writing data to the nonvolatile memory and an access device that communicates with the nonvolatile memory device having the nonvolatile memory, the nonvolatile memory system comprising:
the nonvolatile memory device according to claim 11; and
an access device that accesses a nonvolatile memory device including a nonvolatile memory, the access device comprising:
an adaptive command unit that determines whether data stored in the nonvolatile memory needs maintenance based on a data retention status of the nonvolatile memory obtained from the nonvolatile memory device, and determines whether maintenance is to be performed based on whether the access device is in a system status in which maintenance is enabled and based on whether the data stored in the nonvolatile memory needs maintenance, and generates a maintenance command to the nonvolatile memory device when determining that the maintenance is to be performed.
